(19) United States
(12) Patent Application Publication
(10) Pub. No.: US 2026/0109492 A1
(43) Pub. Date: Apr. 23, 2026

(54) AERIAL VEHICLES AND SYSTEMS AND METHODS FOR PROPULSION OF AERIAL VEHICLES

(71) Applicant: Liviu Grigorian Giurca, Craiova (RO)

(72) Inventor: Liviu Grigorian Giurca, Craiova (RO)

(21) Appl. No.: 18/955,766

(22) Filed: Nov. 21, 2024

Related U.S. Application Data
(60) Provisional application No. 63/601,865, filed on Nov. 22, 2023.

(51) Int. Cl. B64U 10/20; B64U 30/10; B64U 30/29; B64U 101/18; B64U 101/60

(52) U.S. Cl. CPC B64U 10/20; B64U 30/10; B64U 30/29; B64U 2101/18; B64U 2101/60

(57) ABSTRACT

A vertical take-off and landing (VTOL) aerial vehicle includes a power source, a fuselage assembly, and a propulsion system. The fuselage assembly includes a body defining a first axis and a plurality of supports extending from the body. The propulsion system includes a thruster assembly positioned on the plurality of supports and diametrically opposed wings extending from the fuselage assembly. The wings define a second axis perpendicular to the first axis. The thruster assembly is configured to generate an airflow and includes a plurality of rotors arranged symmetrically along the first axis and at least one electric motor configured to power the plurality of rotors.

### CROSS REFERENCE TO RELATED APPLICATIONS

The present application claims the benefit of and priority to U.S. Provisional Patent Application No. 63/601,865 , filed on Nov. 22, 2023, the entire contents of which are hereby incorporated by reference in their entirety.

### TECHNICAL FIELD

The present disclosure relates to aerial vehicles and, more specifically, to systems and methods for propulsion of aerial vehicles with vertical take-off and landing (VTOL) capabilities.

### BACKGROUND

Vertical take-off and landing (VTOL) aerial vehicles typically achieve flight using tilting wings and/or tilting rotors. VTOLs often require complex and expensive mechanisms to achieve stability and control of relative positions between the thrust producing elements and the fuselage. These difficulties are compounded due to changes in a relative position between a center of pressure and a center of gravity of the VTOL, especially during the transition period. The static, horizontal position of the fuselage further complicates stability and control efforts. As a result, a minor mistake can cause a major accident. For example, if a pivoting mechanism becomes stuck in the horizontal flight position, the VTOL can no longer land vertically.

Most VTOL solutions employ distributed electric propulsion (DEP) without using additional aerodynamic phenomena to reduce the thrust/weight ratio. While multi-rotor aerial vehicles are also known, they do not include wings to achieve an efficient flight in a horizontal direction. Moreover, the speed and range of existing VTOL vehicles are often limited.

Accordingly, there is a need for a new, more efficient system to achieve both vertical and horizontal flight.

### SUMMARY

In accordance with aspects of the present disclosure, a vertical take-off and landing (VTOL) aerial vehicle includes a power source, a fuselage assembly, and a propulsion system. The fuselage assembly includes a body defining a first axis and a plurality of supports extending from the body. The propulsion system includes a thruster assembly positioned on the plurality of supports and diametrically opposed wings extending from the fuselage. The wings define a second axis perpendicular to the first axis. The thruster assembly is configured to generate an airflow. The thruster assembly includes a plurality of rotors arranged symmetrically along the first axis and at least one electric motor configured to power the plurality of rotors.

In an aspect of the present disclosure, the power source may be a hybrid energy source or a battery pack.

In another aspect of the present disclosure, the plurality of rotors may include front rotors disposed above a top portion of the fuselage, middle rotors disposed above a central portion of the fuselage, and rear rotors disposed above a back portion of the fuselage.

In yet another aspect of the present disclosure, the front rotors and the rear rotors may be tractor rotors each including a plurality of blades. A pitch angle of the plurality of blades may be configured for horizontal flight.

In a further aspect of the present disclosure, the middle rotors may be pusher rotors including a plurality of folding blades. A pitch angle of the plurality of blades may be configured for vertical flight.

In yet a further aspect of the present disclosure, planes of rotation of the plurality of rotors may be substantially horizontal when the aerial vehicle is in a static position.

In an aspect of the present disclosure, planes of rotation of the front rotors and rear rotors may be offset from a plane of rotation of the middle rotors.

In another aspect of the present disclosure, a diameter of the middle rotors may range from about 1.05 to 1.8 times larger than a diameter of each of the front rotors and the rear rotors.

In yet another aspect of the present disclosure, the diametrically opposed wings may include a front wing and a rear wing. Each of the front wing and the rear wing may be disposed at an angle between about 25 to 85 degrees relative to the second axis when the aerial vehicle is in a static position.

In a further aspect of the present disclosure, the fuselage may include a docking mechanism configured to attach a payload to the aerial vehicle.

In yet a further aspect of the present disclosure, the payload may include a cabin configured to hold a passenger, a container configured to transport an item, or a terrestrial vehicle.

In an aspect of the present disclosure, the aerial vehicle may include landing gear including a plurality of struts configured to attach a payload to the aerial vehicle.

In another aspect of the present disclosure, the payload may include a torpedo, a missile, or a bomb.

In yet another aspect of the present disclosure, the aerial vehicle may include a multi-rocket launcher configured to launch a plurality of rockets.

In accordance with aspects of the present disclosure, a propulsion system for an aerial vehicle includes a thruster assembly, a front wing, a rear wing, a processor, and a memory. The thruster assembly is positioned on a plurality of supports and is configured to generate an airflow. The thruster assembly includes front rotors disposed above a top portion of a fuselage, middle rotors disposed above a central portion of the fuselage, rear rotors disposed above a back portion of the fuselage, and electric motors configured to power each of the front, middle, and rear rotors. The memory includes instructions stored thereon which, when executed by the processor, cause the system to: in a first phase, produce a greater lifting force than a thrusting force, generating vertical flight; in a second phase, accelerate the rear rotors in relation to the front rotors, altering a pitch angle of the aerial vehicle; in a third phase, position the front wing and the rear wing at an angle of attack, generating horizontal flight; in a fourth phase, deactivate the middle rotors to maintain a horizontal flight speed; and in a fifth phase, reactivate the middle rotors to generate an increased thrusting force.

In an aspect of the present disclosure, each of the front, middle, and rear rotors may include a plurality of blades.

In another aspect of the present disclosure, during horizontal flight, a pitch angle of the plurality of blades of the front rotors and the rear rotors may be increased.

In yet another aspect of the present disclosure, during vertical flight, the pitch angle of the plurality of blades of the front rotors and the rear rotors may be decreased.

In a further aspect of the present disclosure, during the fourth phase, the plurality of blades of the middle rotors fold backwards.

Further details and aspects of exemplary aspects of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a side, perspective view of a propulsion system including an aerial vehicle ready for takeoff, in accordance with aspects of the present disclosure;

FIG. 2 is a side, perspective view of the propulsion system of FIG. 1 in a take-off phase, in accordance with aspects of the present disclosure;

FIG. 3 is a side, perspective view of the propulsion system of FIG. 1 in a transition phase, in accordance with aspects of the present disclosure;

FIG. 4 is a side, perspective view of the propulsion system of FIG. 1 in a forward flight phase, in accordance with aspects of the present disclosure;

FIG. 5 is a side, perspective view of the propulsion system of FIG. 1 in a cruising phase, in accordance with aspects of the present disclosure;

FIG. 6 is a front, perspective view of a propulsion system with the middle rotors having a substantially increased diameter, in accordance with aspects of the present disclosure;

FIG. 7 is a front, perspective view of a propulsion system with self-adaptive front and rear rotors, in accordance with aspects of the present disclosure;

FIG. 8 is a front, perspective view of a propulsion system, in accordance with aspects of the present disclosure;

FIG. 9 is a front, perspective view of the propulsion system of FIG. 8 transporting a cabin, in accordance with aspects of the present disclosure;

FIG. 10 is a front, perspective view of the propulsion system of FIG. 8 transporting a container, in accordance with aspects of the present disclosure;

FIG. 11 is a front, perspective view of the propulsion system of FIG. 8 transporting a terrestrial vehicle, in accordance with aspects of the present disclosure;

FIG. 12 is a front, perspective view of a propulsion system, in accordance with aspects of the present disclosure;

FIG. 13 is a front, perspective view of a propulsion system for weapon transport, in accordance with aspects of the present disclosure;

FIG. 14 is a front, perspective view of a propulsion system having a multi-rocket launcher, in accordance with aspects of the present disclosure;

FIG. 15 is an exemplary illustration of a propulsion system during horizontal and vertical flight; and FIG. 16 is a block diagram of a controller of the system of FIG. 1, in accordance with aspects of the present disclosure.

Further details and exemplary aspects of the disclosure are described in more detail below with reference to the appended figures. Any of the above aspects and aspects of the disclosure may be combined without departing from the scope of the disclosure.

### DETAILED DESCRIPTION

Aspects of the present disclosure are described in detail with reference to the drawings wherein like reference numerals identify similar or identical elements.

The phrases “in an aspect,” “in aspects,” “in various aspects,” “in some aspects,” or “in other aspects” may each refer to one or more of the same or different aspects in accordance with the present disclosure.

Although the present disclosure will be described in terms of specific aspects, it will be readily apparent to those skilled in this art that various modifications, rearrangements, and substitutions may be made without departing from the spirit of the present disclosure. The scope of the present disclosure is defined by the claims appended hereto. For purposes of promoting an understanding of the principles of the present disclosure, reference will now be made to exemplary aspects illustrated in the drawings, and specific language will be used to describe the same.

The present disclosure relates to aerial vehicles and more specifically to a propulsion system for vertical take-off and landing (VTOL) aerial vehicles. The system is configured to transition from a vertical take-off mode to a horizontal flight mode and/or from a horizontal flight mode to a vertical landing mode using a number of fixed, thrust-producing elements. The thrust-producing elements are configured to induce additional aerodynamic phenomena with a positive effect on minimal, fixed lift-producing surfaces during vertical and horizontal flight.

The system contains various advantageous features to improve the efficiency of VTOL flight. For example, the system has a simple, compact construction with a high level of redundancy, which reduces the complexity and manufacturing price of the aerial vehicle. For example, the system does not require actuators to produce thrust. Moreover, while compact, the system remains stable during flight. This can reduce the footprint of the system and minimize the space required for ground storage. In addition, rotors of the system are protected against contact with material limitations of the surrounding space and/or people on the ground. Any drag when advancing in the air is also limited. Moreover, the system is versatile to execute different mission profiles, both civil and military, with minimum modifications. For example, the system provides a convenient and safe means of transporting goods, equipment, and/or people between two locations without special arrangements.

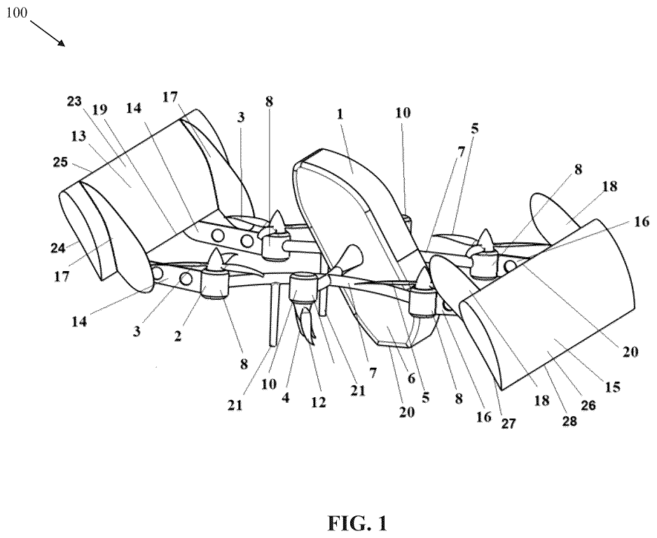

Referring to FIG. 1-5, a system 100 (e.g., a propulsion system) is shown with an aerial vehicle 1 (e.g., VTOL). System 100 may include rotors 3, 4, 5 (e.g., a thruster assembly), a fuselage 6, a support 7, front wing 13, and rear wing 15.

Rotors 3, 4, 5, are configured to maximize a propulsion efficiency in both vertical flight and horizontal (e.g., forward) flight of the aerial vehicle 1. As shown in FIG. 1-5, rotors 3, 4, 5, may each include a pair of rotors. For example, system 100 may contain six rotors, with two rotors 3 in a front portion of fuselage 6 (i.e., front rotors), two rotors 4 in a middle portion of fuselage 6 (i.e., middle rotors), and two rotors 5 in a rear portion of fuselage 7 (i.e., rear rotors). Generally, rotors 3, 4, 5 are disposed between the front wing 13 and the rear wing 15. Rotors 3, 4, 5 may be fixed symmetrically on opposing sides of fuselage 6 by support 7. However, it will be understood that various alternative numbers and/or configurations of rotors 3, 4, 5 are contemplated and within the scope of this disclosure.

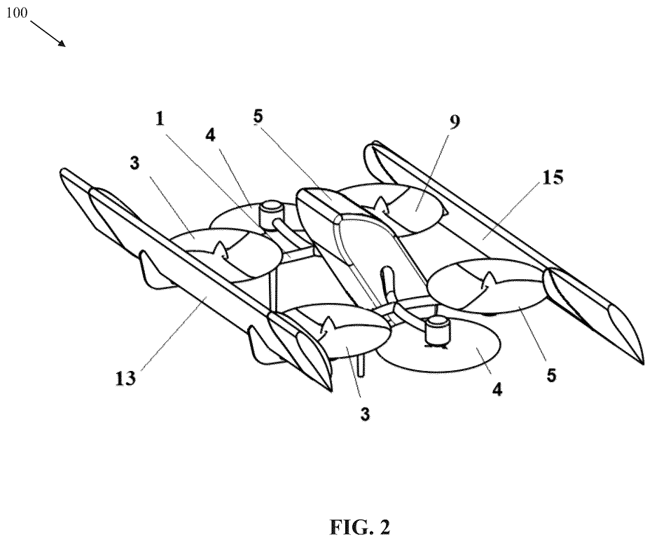

In aspects, rotors 3 and 5 may be tractor rotors, and/or rotors 4 may be pusher rotors. Rotors 3, 4, and/or 5 may be powered by an electric motors 8, 10 (e.g., electric motor assemblies). Electric motors 8 may include front electric motors and rear electric motors. In aspects, one electric motor (e.g., one of electric motors 8, 10) may drive one rotor (e.g., one of rotors 3, 4, 5), although alternative configurations are envisioned. During take-off (FIG. 2) and landing, aerial vehicle 1 may be in a static position, and plane of rotation of each rotor 3, 4 and 5 may be substantially horizontal or slightly inclined.

Rotors 4 may be positioned at a greater distance from fuselage 6 than rotors 3 and 5. In aspects, rotors 4 may include folding blades 12. Planes of rotation of rotors 3 and 5 may be offset from planes of rotation of rotors 4. In aspects, a portion of the planes of rotation of rotors 3, 5, and 5 may overlap to reduce the overall size of the planes of rotate and/or to increase efficiency of rotors 3, 4, 5. In aspects, a change in pitch angle may be implemented, which can significantly influence the efficiency of flight, e.g., to minimize drag, reduce resistance to rotation (e.g., allowing an engine to operate more easily at low speeds), and/or improve aerodynamic efficiency during horizontal flight. Rotors 3 and 5 may have a fixed pitch angle optimized for horizontal forward flight. For example, a decreased pitch angle may be desirable to reduce drag for forward motion during horizontal flight. Rotors 4 may have pitch angle optimized for vertical flight. For example, an increased pitch angle may be desirable to provide lift and minimize drag for hovering and/or low-speed maneuvering during vertical flight.

Front wing 13 may include an upper surface 23, a lower surface 24, a trailing edge 19, and a leading edge 25. Rear wing 15 may include an upper surface 26 a lower surface 27, a trailing edge 28 and a leading edge 20. In aspects, front wing 13 and/or rear wing 15 may define a lift-producing surface (e.g., each may include an airfoil). When the aerial vehicle 1 is in horizontal flight, front wing 13 may be positioned so that the planes of rotation of rotors 3 are located near trailing edge 19 of front wing 13 and above upper surface 23. When aerial vehicle 1 is in horizontal flight, rear wing 15 may be positioned so that the rotation planes of rotors 5 are located near leading edge 20 of rear wing 15 and below lower surface 27.

Front wing 13 may be fixed symmetrically to front electric motors 8 by brackets 14. Rear wing 15 may be fixed symmetrically to rear electric motors 8 by bracket 16. While two brackets 14 and one bracket 16 are shown, any number and/or configuration of brackets may be used and are within the scope of the disclosure. When aerial vehicle 1 is in a static position, front wing 13 makes an incidence angle with a horizontal plane between about 25° and 85° and rear wing 15 makes an incidence angle with the horizontal plane between about 25° and 85°. In aspects, each of front wing 13 and rear wing 15 may have two jet limiters 17, 18 that limit and/or channelize air flow produced by rotors 3 and 5.

Fuselage 6 may be mounted lengthwise along system 100, defining a longitudinal axis. The longitudinal axis may be substantially similar to a chord of front wings 13 and of a chord of rear wings 15, exposing minimal surface area to frontal air flow during horizontal flight of aerial vehicle 1. In aspects, fuselage 6 may have an aerodynamic shape. Fuselage 6 may include a rear flattened surface 21 to provide support during take-off and/or landing of aerial vehicle 1. In aspects, each support 7 may include a leg 22 to provide support during take-off and/or landing of aerial vehicle 1. In aspects, the aerial vehicle 1 may be powered by a battery pack and/or a hybrid energy source.

The rotors 3, 4, 5 (i.e., thruster assembly) may be configured to generate both vertical and horizontal thrust. A lifting force, vertical thrusting force, and/or horizontal thrusting force produced may vary, depending on which phase the system 100 is in.

In a first phase (e.g., in a take-off phase) (FIG. 2), all of rotors 3, 4 and 5 may be activated, producing a greater lifting force than a thrusting force. Rotors 3 may produce a depression on the upper surface 23 of front wing 13, which can amplify a vertical thrust force. Simultaneously, rotors 5 may produce an increased pressure on the lower surface 27 of rear wing 15, which can amplify the vertical thrust force.

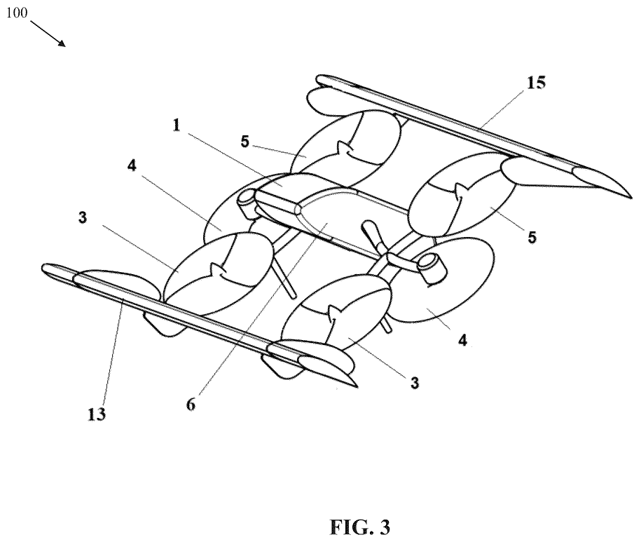

In a second phase (e.g., a transition phase) (FIG. 3), a rate of motion of rotors 5 may be additionally accelerated, tilting (i.e., altering a pitch angle) of the aerial vehicle 1 as the aerial vehicle 1 starts to move in forward direction (i.e., transitioning between vertical flight and horizontal flight).

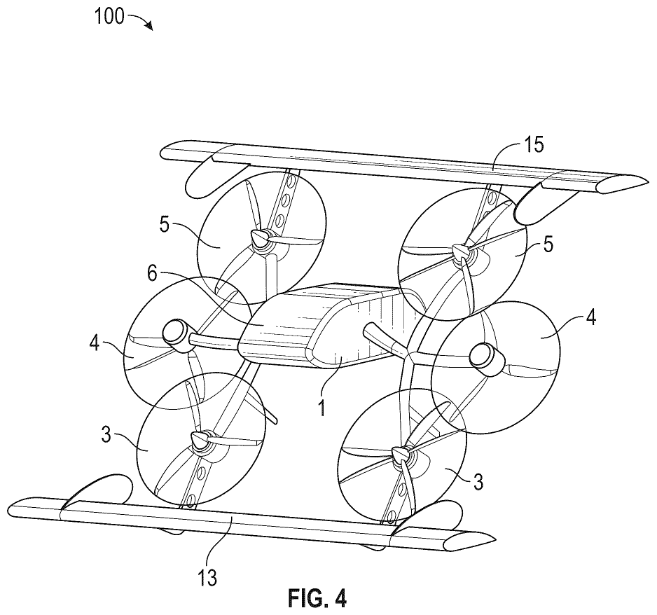

In a third phase (e.g., a forward flight phase) (FIG. 4), system 100 may generate forward, horizontal flight. Front wings 13 and rear wings 15 may have an attack angle to generate a majority of the lifting force. The propulsion efficiency may be improved due to a lift of the front and rear wings.

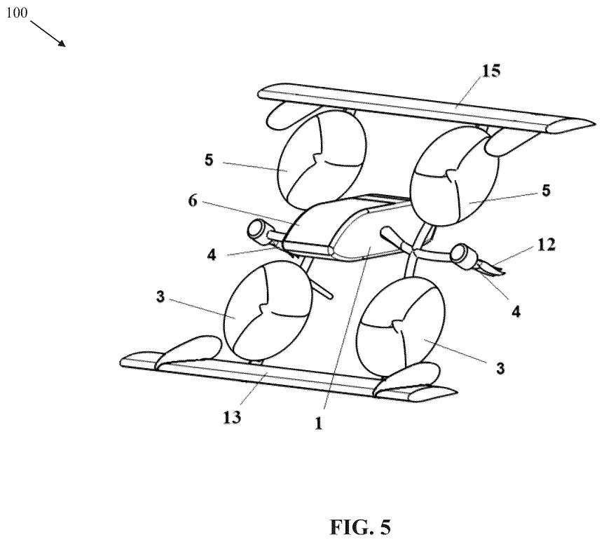

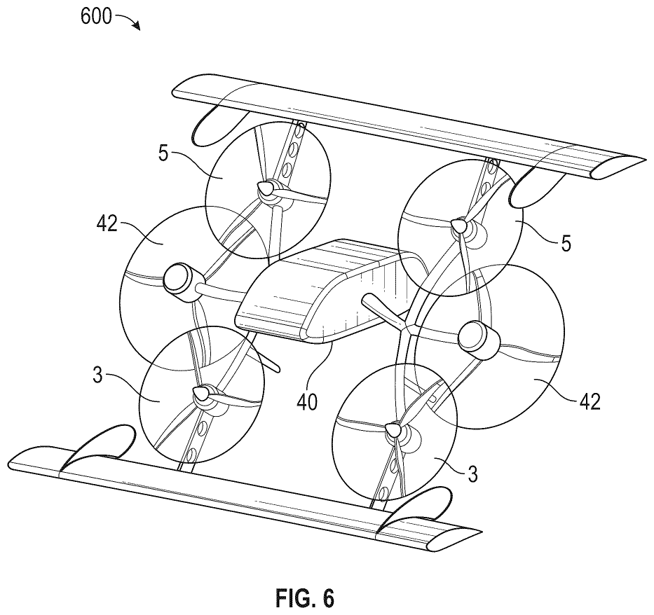

In a fourth phase (e.g., a cruising flight phase) (FIG. 5), aerial vehicle 1 approaches an optimal horizontal speed. Electric motors 10 that actuate rotors 4 may be interrupted (e.g., the electric motors 10 may cut off power to the rotors 4), and folding blades 12 may be pushed backwards due to pressure of the frontal air flow. Consequently, during the fourth phase, rotors 4 may be deactivated, which can decrease energy consumption of aerial vehicle 1.

In a fifth phase (e.g., a landing phase), rotors 4 may be reactivated. For example, rotors 4 may be reactivated when it is necessary to increase a thrusting force in all directions.

Referring now to FIG. 6, a system 600 is shown with an aerial vehicle 40 (e.g., a VTOL). System 600 is similar in aspects to system 100, and for brevity, primarily the differences will be discussed.

System 600 may include rotors 3, 42, and 5. Rotors 3 may be front rotors. Rotors 5 may be rear rotors. Rotors 42 may be middle rotors having a substantially larger diameter than that of rotors 3 and 5, respectively, the diameter of rotors 42 being from about 1.05 to about 1.8 times the diameter of rotors 3 and 5.

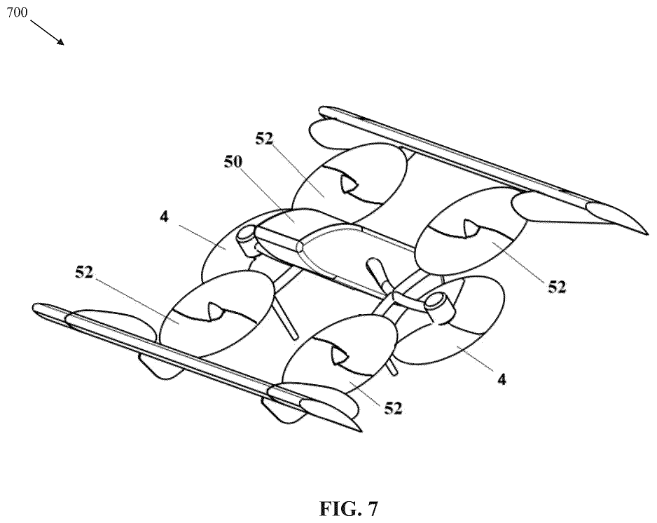

Referring now to FIG. 7, a system 700 is shown with an aerial vehicle 50 (e.g., a VTOL). System 700 is similar in aspects to systems 100 and 600, and for brevity, primarily the differences will be discussed.

System 700 may include rotors 4 and 52. Rotors 4 may be middle rotors. Rotors 52 may be front rotors and rear rotors. Rotors 4 may be configured with self-adaptive pitch to adaptively change the pitch angle of the rotors 4 as the speed and/or the flight phase changes, so that the aerial vehicle 50 maximizes efficiency in vertical and forward flight.

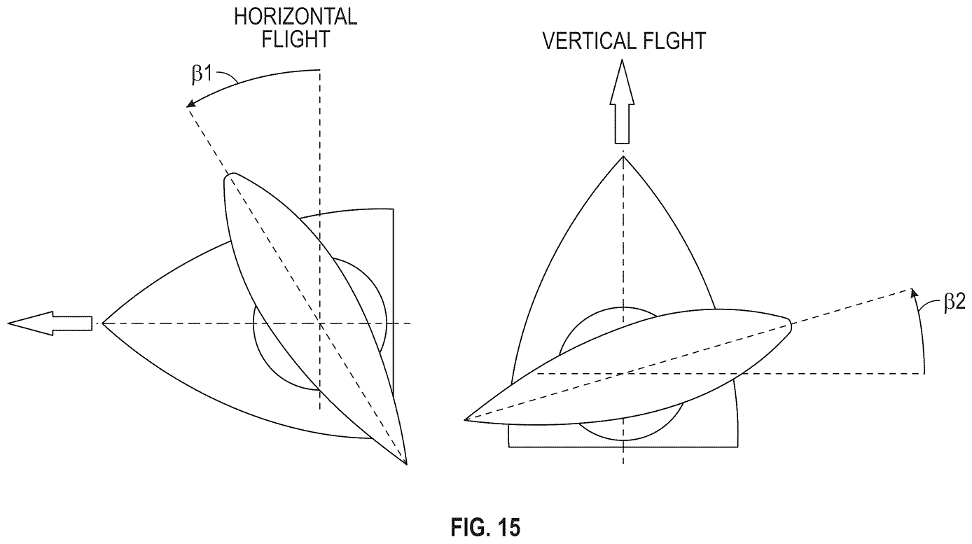

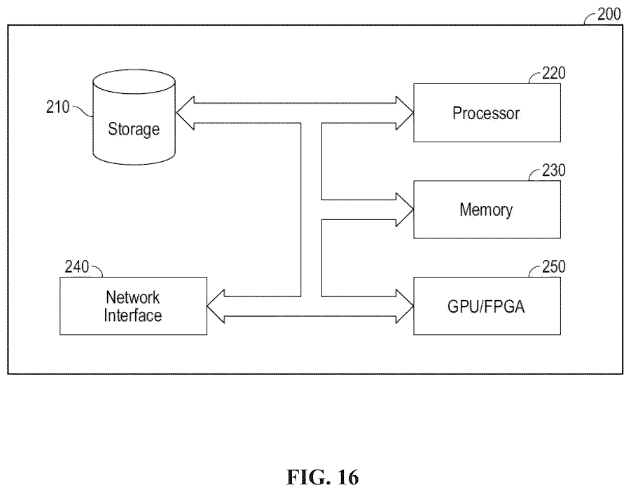

During vertical flight (e.g., take-off, landing and/or hovering), rotors 52 may have a reduced pitch angle that determines a high efficiency (FIG. 15). During horizontal flight, rotors 52 may have a substantially increased pitch angle, (e.g., higher than during vertical flight), determining a high efficiency (FIG. 15). In aspects, the pitch angle of rotors 52 may change automatically with a rotation speed of rotors 52. Generally, rotors 4 are active during take-off/landing, hovering, transitioning between horizontal and vertical flight, and/or when system 100 is operating at a maximum speed, although other configurations are envisioned.

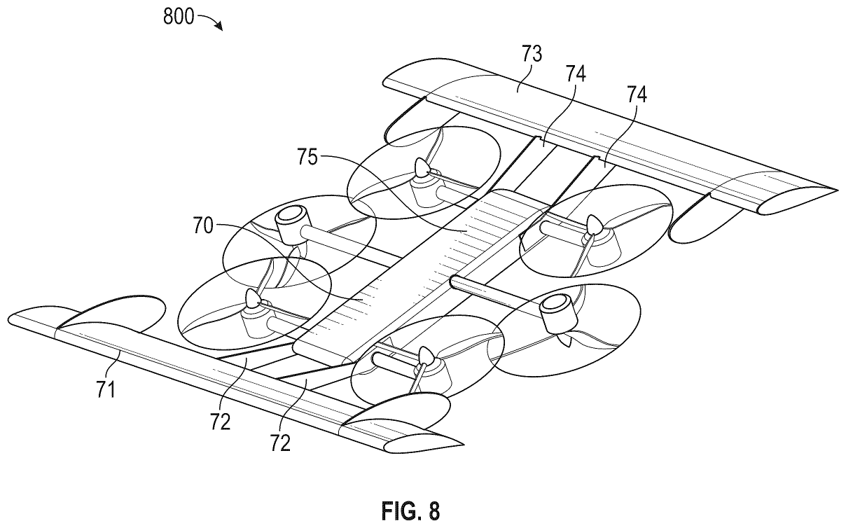

Referring now to FIG. 8-11, a system 800 is shown with an aerial vehicle 70 (e.g., a VTOL or propulsion module). System 800 is similar in aspects to systems 100, 600, and 700, and for brevity, primarily the differences will be discussed.

System 800 may include a front wing 71, a rear wing 73, and a fuselage 75. Front wing 71 may be fixed to fuselage 75 by front brackets 72 and rear wing 73 may be fixed to fuselage by rear brackets 74. While two brackets 72, 74 are shown, any number and/or configuration of brackets may be used and are within the scope of the disclosure. Fuselage 75 may define a longitudinal axis. In aspects, fuselage 75 may have a substantially parallelepiped shape. System 800 and/or aerial vehicle 70 may operate in an automatic mode by using at least a processor, a Global Positioning System sensor, a multi-detection sensor and/or a memory (FIG. 16).

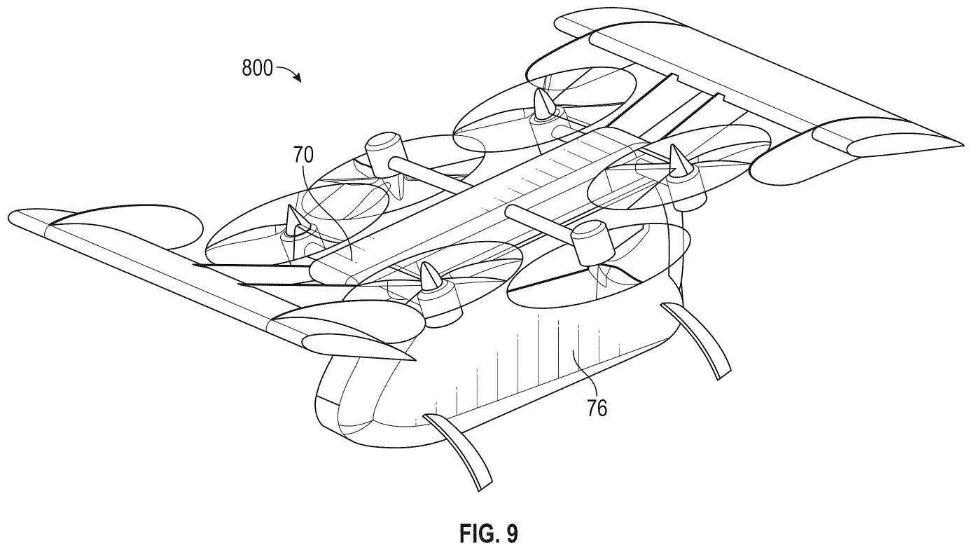

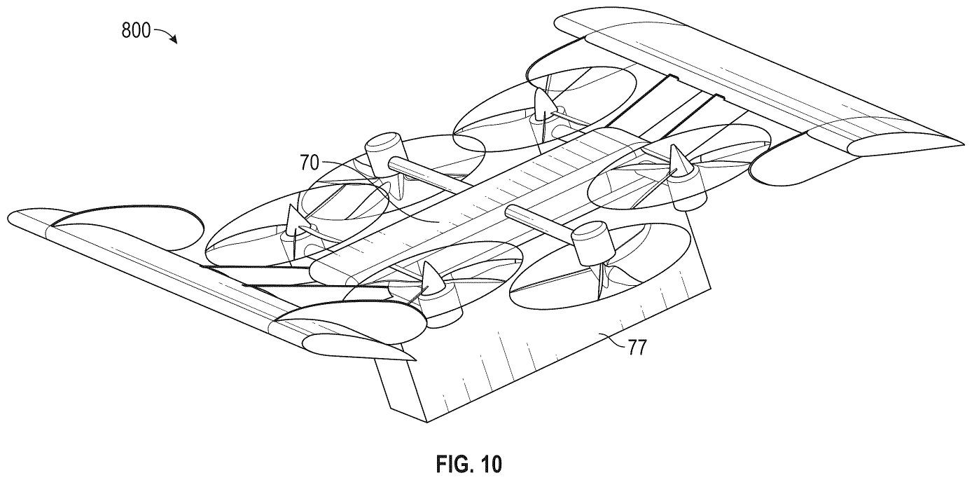

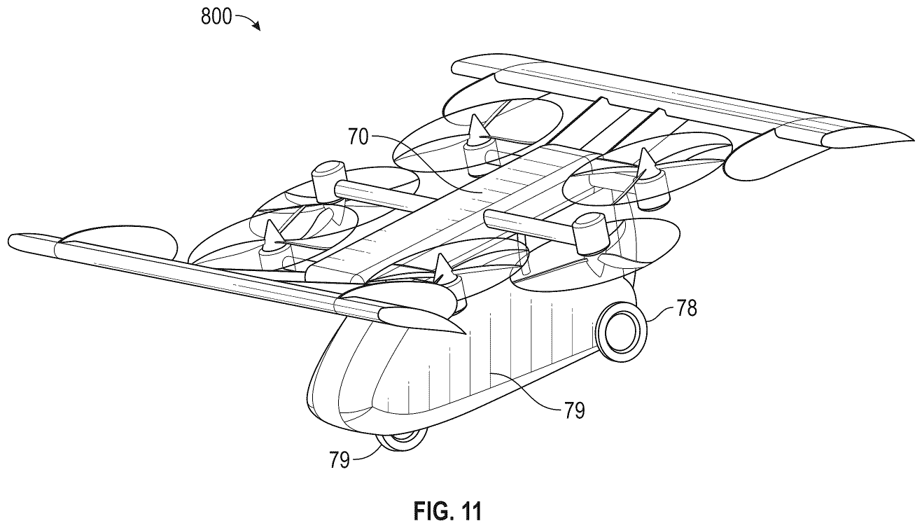

In aspects, a docking mechanism (not shown) may be mounted underneath the fuselage 75. The docking mechanism may be used to connect with various transportable elements. For example, the transportable element may be a cabin 76 (FIG. 9), which can be attached to aerial vehicle 70 by the docking mechanism. The cabin 76 may be used to transport at least one passenger (not shown). In aspects, the cabin 76 may have an aerodynamic shape. In another example, the transportable element may be a container 77 (FIG. 10), which can be attached to aerial vehicle 70 by the docking mechanism. Container 77 may be used to transport various items, including equipment, goods, and/or water for firefighting. In another example, the transportable element may be a terrestrial vehicle 78 (FIG. 11), which can be attached to aerial vehicle 70 by the docking mechanism. The terrestrial vehicle 78 may include at least three wheels 79, which can be driven by a terrestrial powertrain (not shown). The terrestrial vehicle 78 can fly with the help of the system 800 and/or aerial vehicle 70 and/or can move by itself on the ground.

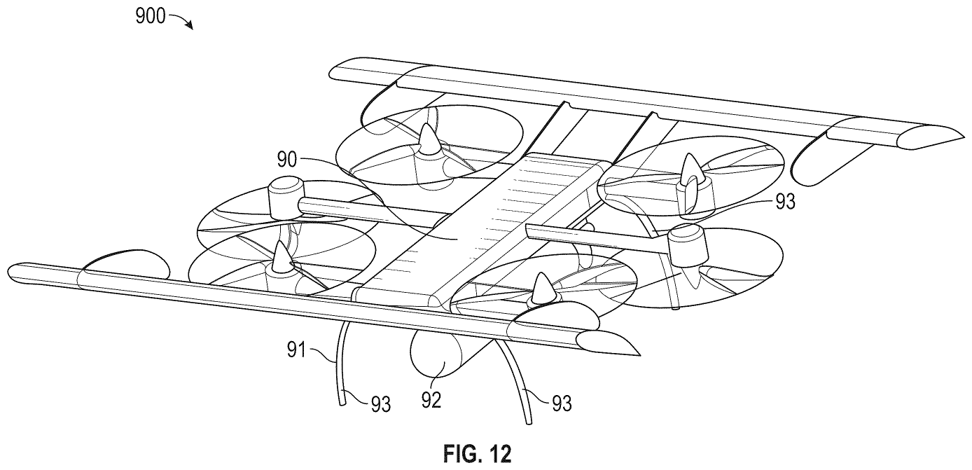

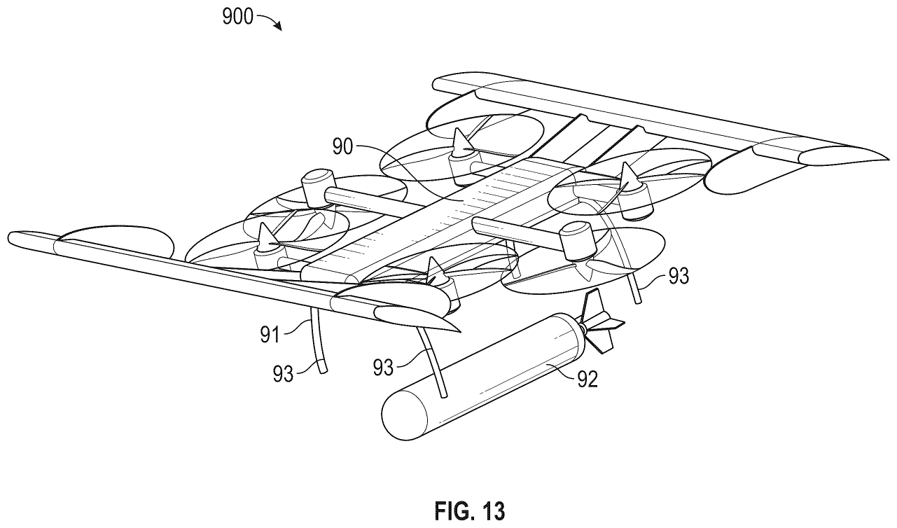

Now referring to FIGS. 12 and 13, a system 900 is shown with an aerial vehicle 90 (e.g., a VTOL). System 900 is similar in aspects to systems 100, 600, 700, and 800, and for brevity, primarily the differences will be discussed.

System 900 may include landing gear 91, having four struts 93. The landing gear may be connected to the fuselage. A weapon 92 may be suspended underneath aerial vehicle 90 and/or between struts 93. The weapon may be suspended with the help of a docking system (not shown). In aspects, weapon 92 may be an anti-ship torpedo, a missile (e.g., flying missile), and/or a bomb. In operation, weapon 92 may be released from aerial vehicle 90 during flight (FIG. 13).

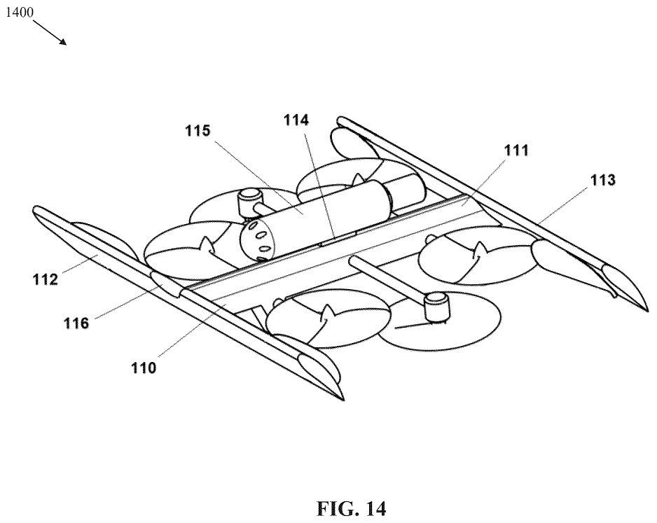

Now referring to FIG. 14, a system 1400 is shown with an aerial vehicle 110 (e.g., a VTOL). System 1400 is similar in aspects to systems 100, 600, 700, 800, and 900, and for brevity, primarily the differences will be discussed.

System 1400 may include a fuselage 111, a front wing 112, a rear wing 113, a support 114, and a multi-rocket launcher 115. Front wing 112 and rear wing 113 may be directly connected to fuselage 111. Multi-rocket launcher 115 may be affixed to a middle portion of fuselage 111 by support 114. A semi-round opening 116 may be formed in a central portion of front wing 112. In aspects, multi-rocket launcher 115 may contain rockets (not shown), which can be launched automatically and/or commanded by an operator. The semi-round opening 116 may be large enough to permit the rockets to be launched therethrough, so that the rockets do not contact the front wing 112.

Now referring to FIG. 15, an exemplary illustration of a system 100, 600, 700, 800, 900, 1400 is shown during both horizonal and vertical flight. As discussed above, during vertical flight, rotors may have a reduced pitch angle (β2) that determines a high efficiency. In aspects, during vertical flight, a vertical velocity may be increased, resulting in higher drag. During horizontal flight, rotors may have a substantially increased pitch angle (β1), determining a high efficiency. In aspects, during horizontal flight, a horizontal velocity may be increased, resulting in lower drag.

Referring now to FIG. 16, exemplary components in the controller 200 are shown. Controller 200 may be used with any of systems 100, 600, 700, 800, 900, and 1400. In accordance with aspects of the present disclosure, controller 200 includes, for example, a database 210, one or more processors 220, at least one memory 230, and a network interface 240. In aspects, the controller 200 may include a graphical processing unit (GPU) 250, which may be used for processing machine learning network models.

Database 210 can be located in storage. The term “storage” may refer to any device or substrate from which information may be capable of being accessed, reproduced, and/or held in an electromagnetic or optical form for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In aspects, data may be stored on controller 200, including, for example, user preferences, historical data, and/or other data. The data can be stored in database 210 and sent via the system bus to processor 220. In aspects, data may be stored in a secure network (e.g., a cloud service) and/or streamed over a 5th generation mobile network or encrypted wireless network.

Processor 220 executes various processes based on instructions that can be stored in the at least one memory 230 (e.g., a server memory) and utilizing the data from database 210. A detection of a parameter (e.g., flight, speed, direction, air flow), can be communicated to the server through the network interface 240. The illustration of FIG. 16 is exemplary, and persons skilled in the art will understand that other components may exist in a controller 200. Such other components are not illustrated in FIG. 16 for clarity of illustration.

It should be understood that the foregoing description is only illustrative of the present disclosure. Various alternatives, modifications, and variances can be devised by those skilled in the art without departing from the disclosure. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in any appropriately detailed structure. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A vertical take-off and landing (VTOL) aerial vehicle, comprising:
a power source;
a fuselage assembly, including:
a body defining a first axis; and
a plurality of supports extending from the body;
a propulsion system, including:
a thruster assembly positioned on the plurality of supports, the thruster assembly configured to generate an airflow, and including:
a plurality of rotors arranged symmetrically along the first axis; and
at least one electric motor configured to power the plurality of rotors; and
diametrically opposed wings extending from the fuselage assembly, the
diametrically opposed wings defining a second axis perpendicular to the first axis.

2. The aerial vehicle of claim 1, wherein the power source is at least one of a hybrid energy source or a battery pack.

3. The aerial vehicle of claim 1, wherein the plurality of rotors includes:
front rotors disposed above a top portion of the fuselage assembly;
middle rotors disposed above a central portion of the fuselage assembly; and
rear rotors disposed above a back portion of the fuselage assembly.

4. The aerial vehicle of claim 3, wherein the front rotors and the rear rotors are tractor rotors each including a plurality of blades, and wherein a pitch angle of the plurality of blades is configured for horizontal flight.

5. The aerial vehicle of claim 4, wherein the middle rotors are pusher rotors including a plurality of folding blades, and wherein a pitch angle of the plurality of blades is configured for vertical flight.

6. The aerial vehicle of claim 3, wherein planes of rotation of the plurality of rotors are substantially horizontal when the aerial vehicle is in a static position.

7. The aerial vehicle of claim 6, wherein planes of rotation of the front rotors and rear rotors are offset from a plane of rotation of the middle rotors.

8. The aerial vehicle of claim 3, wherein a diameter of the middle rotors ranges from about 1.05 to 1.8 times larger than a diameter of each of the front rotors and the rear rotors.

9. The aerial vehicle of claim 1, wherein the diametrically opposed wings include a front wing and a rear wing, wherein each of the front wing and the rear wing are disposed at an angle between about 25 to 85 degrees relative to the second axis when the aerial vehicle is in a static position.

10. The aerial vehicle of claim 1, wherein the fuselage assembly includes a docking mechanism configured to attach a payload to the aerial vehicle.

11. The aerial vehicle of claim 10, wherein the payload includes at least one of a cabin configured to hold a passenger, a container configured to transport an item, or a terrestrial vehicle.

12. The aerial vehicle of claim 1, further comprising landing gear including a plurality of struts configured to attach a payload to the aerial vehicle.

13. The aerial vehicle of claim 12, wherein the payload includes at least one of a torpedo, a missile, or a bomb.

14. The aerial vehicle of claim 1, further comprising a multi-rocket launcher configured to launch a plurality of rockets.

15. A propulsion system for an aerial vehicle, comprising:
a thruster assembly positioned on a plurality of supports, the thruster assembly configured to generate an airflow, and including:
front rotors disposed above a top portion of a fuselage;
middle rotors disposed above a central portion of the fuselage; and
rear rotors disposed above a back portion of the fuselage; and
electric motors configured to power each of the front rotors, middle rotors, and
rear rotors;
a front wing;
a rear wing;
a processor; and
a memory including instructions stored thereon which, when executed by the processor, cause the system to:
in a first phase, produce a greater lifting force than a thrusting force, generating vertical flight;
in a second phase, accelerate the rear rotors in relation to the front rotors, altering a pitch angle of the aerial vehicle;
in a third phase, position the front wing and the rear wing at an angle of attack, generating horizontal flight;
in a fourth phase, deactivate the middle rotors to maintain a horizontal flight speed; and
in a fifth phase, reactivate the middle rotors to generate an increased thrusting force.

16. The propulsion system of claim 15, wherein each of the front rotors, middle rotors, and rear rotors includes a plurality of blades.

17. The propulsion system of claim 16, wherein during horizontal flight, a pitch angle of the plurality of blades of the front rotors and the rear rotors is increased.

18. The propulsion system of claim 16, wherein during vertical flight, the pitch angle of the plurality of blades of the front rotors and the rear rotors is decreased.

19. The propulsion system of claim 16, wherein during the fourth phase, the plurality of blades of the middle rotors fold backwards.

20. A vertical take-off and landing (VTOL) aerial vehicle, comprising:
a power source;
a fuselage assembly, including:
a body defining a first axis; and
a plurality of supports extending from the body;
a propulsion system, including:
a thruster assembly positioned on the plurality of supports, the thruster assembly configured to generate an airflow, and including:
front rotors disposed above a top portion of the fuselage assembly;
middle rotors disposed above a central portion of the fuselage assembly; and
rear rotors disposed above a back portion of the fuselage assembly; and
electric motors configured to power the front rotors, middle rotors, and
rear rotors;
a front wing;
a rear wing;
a processor; and
a memory including instructions stored thereon which, when executed by the processor, cause the system to:
in a first phase, produce a greater lifting force than a thrusting force, generating vertical flight;
in a second phase, accelerate the rear rotors in relation to the front rotors, altering a pitch angle of the aerial vehicle;
in a third phase, position the front wing and the rear wing at an angle of attack, generating horizontal flight;
in a fourth phase, deactivate the middle rotors to maintain a horizontal flight speed; and
in a fifth phase, reactivate the middle rotors to generate an increased thrusting force.
